(19) United States
(12) Patent Application Publication
(10) Pub. No.: US 2024/0416445 A1
(43) Pub. Date: Dec. 19, 2024

(54) DUAL WIRE DRIVE SYSTEM

(71) Applicant: Lincoln Global, Inc., Santa Fe Springs, CA (US)

(72) Inventors: Jordan Thai, Mentor, OH (US); Alexander C. Mehlman, Strongsville, OH (US)

(21) Appl. No.: 18/381,364

(22) Filed: Oct. 18, 2023

Related U.S. Application Data
(60) Provisional application No. 63/521,120, filed on Jun. 15, 2023.

(51) Int. Cl. B23K 9/133

(52) U.S. Cl. CPC B23K 9/1336; B33Y 40/00

(57) ABSTRACT

A welding or additive manufacturing wire drive system includes a shaft. An inner spindle is mounted on the shaft. The inner spindle has a first hub for receiving a first welding wire spool mounted on the inner spindle, and a first flange around the first hub. An outer spindle is mounted coaxially on the shaft with the inner spindle and includes a second hub for receiving a second welding wire spool mounted on the outer spindle, and a second flange around the second hub. A first friction brake is in contact with the inner spindle. A second friction brake is in contact with the outer spindle. A biasing member is located between the inner spindle and the outer spindle and applies a bias force from the outer spindle to the inner spindle to push the inner spindle against the first friction brake. The inner spindle and the outer spindle are configured for independent rotation at different angular velocities from each other.

### CROSS-REFERENCE TO RELATED APPLICATIONS

The present application claims priority to U.S. Provisional Patent Application Ser. No. 63/521,120 filed on Jun. 15, 2023, the disclosure of which is incorporated herein by reference.

### BACKGROUND OF THE INVENTION

### Field of the Invention

The present invention relates to a wire drive system for dual wire welding or additive manufacturing.

### Description of Related Art

When welding, it is often desirable to increase the width of the weld bead or increase the length of the weld puddle during welding. There can be many different reasons for this desire, which are well known in the welding industry. For example, it may be desirable to elongate the weld puddle to keep the weld and filler metals molten for a longer period of time so as to reduce porosity. That is, if the weld puddle is molten for a longer period of time there is more time for harmful gases to escape the weld bead before the bead solidifies. Further, it may desirable to increase the width of a weld bead so as to cover wider weld gap or to increase a wire deposition rate. In both cases, it is common to use an increased electrode diameter. The increased diameter will result in both an elongated and widened weld puddle, even though it may be only desired to increase the width or the length of the weld puddle, but not both. However, this is not without its disadvantages. Specifically, because a larger electrode is employed more energy is needed in the welding arc to facilitate proper welding. This increase in energy causes an increase in heat input into the weld and will result in the use of more energy in the welding operation, because of the larger diameter of the electrode used. Further, it may create a weld bead profile or cross-section that is not ideal for certain mechanical applications.

Rather than increasing the diameter of the electrode, it may be desirable to weld using two smaller wire electrodes simultaneously. The two wire electrodes can be wound on separate spools and driven by a wire feeder through a welding torch during a deposition operation. It can be desirable at certain times for the two spools to rotate together at the same speed during wire feeding while providing for the possibility that the spools should rotate at different relative speeds or angular velocities (i.e., one spool rotating faster than the other during wire feeding).

### BRIEF SUMMARY OF THE INVENTION

The following summary presents a simplified summary in order to provide a basic understanding of some aspects of the devices, systems and/or methods discussed herein. This summary is not an extensive overview of the devices, systems and/or methods discussed herein. It is not intended to identify critical elements or to delineate the scope of such devices, systems and/or methods. Its sole purpose is to present some concepts in a simplified form as a prelude to the more detailed description that is presented later.

In accordance with one aspect of the present invention, provided is a welding or additive manufacturing wire drive system. The system includes a shaft. An inner spindle is mounted on the shaft. The inner spindle has a first hub for receiving a first welding wire spool mounted on the inner spindle, and a first flange around the first hub. An outer spindle is mounted coaxially on the shaft with the inner spindle and includes a second hub for receiving a second welding wire spool mounted on the outer spindle, and a second flange around the second hub. A first friction brake is in contact with the inner spindle. A second friction brake is in contact with the outer spindle. A biasing member is located between the inner spindle and the outer spindle and applies a bias force from the outer spindle to the inner spindle to push the inner spindle against the first friction brake. The inner spindle and the outer spindle are configured for independent rotation at different angular velocities from each other.

In accordance with another aspect of the present invention, provided is a welding or additive manufacturing wire drive system. The system includes a shaft. An inner spindle is mounted on the shaft and includes a first hub for receiving a first welding wire spool mounted on the inner spindle, and a first flange around the first hub. An outer spindle is mounted coaxially on the shaft with the inner spindle and includes a second hub for receiving a second welding wire spool mounted on the outer spindle, and a second flange around the second hub. A first biasing member is located between the inner spindle and the outer spindle. A first friction brake is in contact with the inner spindle. A second biasing member located inside of the outer spindle, and a second friction brake is in contact with the outer spindle and located inside of the outer spindle. The inner spindle and the outer spindle are configured for independent rotation on the shaft at different angular velocities from each other. The second biasing member applies a bias force to the inner spindle through both of the outer spindle and the first biasing member.

In accordance with another aspect of the present invention, provided is a welding or additive manufacturing wire drive system. The system includes a wire feeder housing, and a shaft extending within the wire feeder housing. An inner spindle is mounted on the shaft and includes a first hub for receiving a first welding wire spool mounted on the inner spindle and a first flange around the first hub. An outer spindle is mounted coaxially on the shaft with the inner spindle and includes a second hub for receiving a second welding wire spool mounted on the outer spindle and a second flange around the second hub. A first biasing member is located between the inner spindle and the outer spindle. A first friction brake is in contact with the inner spindle. A second biasing member is located inside of the outer spindle. A second friction brake is in contact with the outer spindle. The inner spindle and the outer spindle are configured for independent rotation within the wire feeder housing on the shaft at different angular velocities from each other. The second biasing member applies a bias force to the inner spindle through both of the outer spindle and the first biasing member.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 shows a wire feeder;

FIG. 2 is a side view of a portion of an example wire feeder;

FIG. 3 shows inner and outer spindles of the wire feeder;

FIG. 4 is an exploded view of various components of the wire feeder;

FIG. 5 shows a stack-up of various components of the wire feeder;

FIG. 6A shows an outer spindle assembly of the wire feeder;

FIG. 6B shows the outer spindle assembly of the wire feeder;

FIG. 7 shows the an outer spindle assembly in exploded view;

FIG. 8 shows the outer spindle;

FIG. 9 shows the outer spindle; and

FIG. 10 shows a shaft and thumb screw of the wire feeder.

### DETAILED DESCRIPTION OF THE INVENTION

The present invention relates to a wire drive system for dual wire welding or additive manufacturing. In particular, the present invention concerns a braking system for spindles that allows two separate welding wire spools to rotate together but independently and at different angular velocities (e.g., slip relative to one another should there be a mismatch in how the wires unwind from the spools). Patent application publication no. US 2023/0017476 published on Jan. 19, 2023 is incorporated by reference and describes a wire drive system for dual wire welding that has a clutch mechanism that allows the two separate welding wire spools mounted together on a spindle to rotate together but also slip relative to one another. The present invention, as discussed in detail below, includes separate spindles for each wire spool and separate friction brakes for each spindle, which allow the spindles to rotate independently at different angular velocities from each other. The friction brakes and also provide a braking function when wire pay out stops, to prevent free-wheeling of the wire spools and unrolling of welding wire within the wire feeder housing, which is undesirable.

The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. Any disjunctive word or phrase presenting two or more alternative terms, whether in the description of embodiments, claims, or drawings, should be understood to contemplate the possibilities of including one of the terms, either of the terms, or both terms. For example, the phrase “A or B” should be understood to include the possibilities of “A” or “B” or “A and B.”

Embodiments of the present invention can be utilized in gas metal arc welding (GMAW), flux-cored arc welding (FCAW), metal-cored arc welding (MCAW), gas tungsten arc welding (GTAW) as well as other similar types of welding operations. Further, embodiments of the present invention can be used in manual, semi-automatic and robotic welding operations. Embodiments of the present invention can also be used in metal deposition operations that are similar to welding, such as additive manufacturing, hardfacing, and cladding. As used herein, the term “welding” is intended to encompass all of these technologies as they all involve material deposition to either join or build up a workpiece. Therefore, in the interests of efficiency, the term “welding” is used below in the description of exemplary embodiments, but is intended to include all of these material deposition operations, whether or not joining of multiple workpieces occurs.

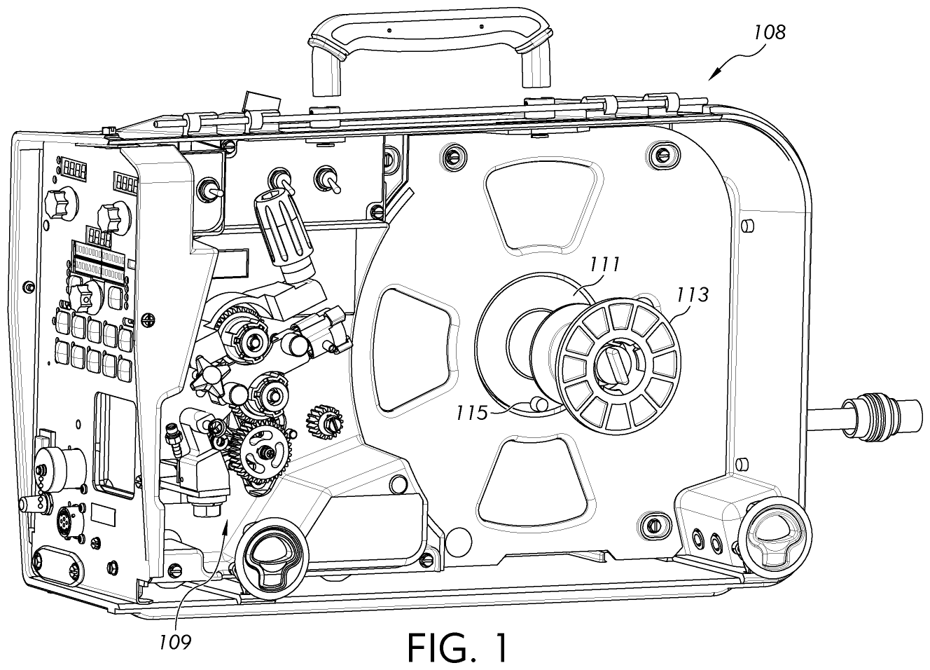

FIG. 1 shows an example portable wire feeder 108 suitable for dual wire welding operations. The wire feeder 108 has a drive system 109 with drive rolls for paying out welding wire from two separate welding wire spools (not shown) simultaneously and delivering the welding wires to a welding torch or gun. An outer case door for the wire feeder housing is removed in FIG. 1 so that the drive system 109 and spindles 111, 113 for the welding wire spools are visible. The wire feeder 108 has an inner spindle 111 and an outer spindle 113. Each spindle 111, 113 has a hub for receiving a welding wire spool and a flange around the hub for holding the spool on the spindle. The spindle flanges can include a pin 115 that is inserted into a corresponding alignment hole or sleeve on a welding wire spool so that the spindles 111, 113 and spools rotate together during wire pay out.

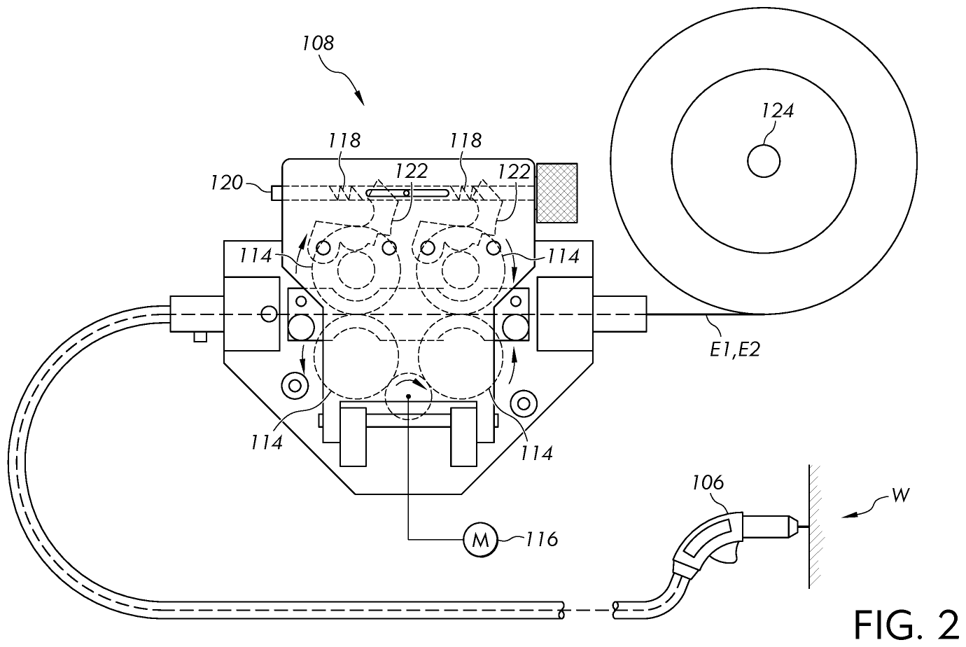

Portions of the example wire feeder 108, in particular the drive system, are shown schematically in FIG. 2. The wire feeder 108 can include a variable speed drive motor 116. The wire feeder 108 and/or drive motor(s) 116 may draw operating power from a welding power supply or an altogether separate power source. Still any manner of providing power to operate the welding wire feeder 108 and/or the drive motors 116 may be chosen with sound engineering judgment as is appropriate for use with the embodiments of the present invention.

The welding wire feeder 108 may include a drive assembly, or drive roll assembly. As mentioned above, the drive motor 116, also called a wire feeder motor, delivers power, i.e. torque, to convey the first and second welding wires E1, E2 through the wire feeder and to the torch 106 and subsequently to the workpiece W. Drive rolls 114 are included that grip the welding wires E1, E2 for pushing or pulling the welding wires simultaneously in the appropriate direction, i.e. toward the workpiece W. Sets of drive rolls 114 are vertically aligned and have corresponding aligned annular or circumferential grooves through which the welding wires E1, E2 pass simultaneously. The welding wires E1, E2 can be located together in the same circumferential grooves on the drive rolls 114 or located in separate circumferential grooves spaced axially apart along the outer surface of the drive rolls. It can be seen that the vertically-aligned sets of drive rolls 114 rotate in opposite directions to drive the welding wires E1, E2 through the wire feeder 108. For example, the upper drive rolls 114 rotate clockwise and the lower drive rolls rotate counterclockwise. The drive rolls 114 may be cylindrical in configuration, or more specifically disk-shaped, although the particular configuration should not be construed as limiting. The surface, i.e. the outer circumference, of the drive rolls 114 may be comprised of a sufficiently hardened material, like steel, that is durable and suitable for gripping the welding wires E1, E2. As shown, the drive rolls 114 may be disposed in pairs along the wire trajectory with each drive roll of the pair being supported on opposing sides of the welding wires E1, E2, such that respective outer circumferential portions of the rolls engage opposite sides of the wires (e.g., from above and below). It is noted that the central axes of respective drive rolls 114 extend substantially parallel with one another and generally transverse to the trajectory of the welding wires E1, E2. Although four drive rolls 114 are illustrated in FIG. 2, the wire feeder 108 can include fewer or more than four drive rolls if desired. In particular, the wire feeder 108 can have at least two drive rolls 114 that simultaneously draw the wire electrodes E1, E2 from their respective spools, at the wire feed speed (WFS).

The wire feeder 108 can include a biasing member that biases the vertically-aligned sets of drive rolls 114 toward one another. The biasing member sets the clamping force or compression that the drive rolls 114 apply to the welding wires E1, E2. For example, the wire feeder 108 can include biasing springs 118 that apply a bias force to one or more drive rolls 114 to set the compression that the drive rolls apply to the welding wires E1, E2. In the example embodiment of FIG. 2, the biasing springs 118 are mounted to an adjusting rod 120 that can be moved inward and outward to adjust the compression of the biasing springs 118. The force of the biasing springs 118 is transferred to the upper drive rolls 114 via pivoting levers 122. As noted above, the vertically-aligned sets of drive rolls 114 have corresponding aligned annular or circumferential grooves through which the wending wires E1, E2 pass. Further details regarding the structure of welding wire feeders can be found in U.S. Pat. No. 5,816,466 issued on Oct. 6, 1998 and U.S. Pat. No. 8,569,653 issued on Oct. 29, 2013, both of which are incorporated herein by reference.

As the wire electrodes E1, E2 are drawn off of the spools at the WFS, the spools can rotate at the same speed or at different speeds. If the spools contain the same amount of welding wire, they will tend to rotate at the same speed during pay out of the wire. However, if the spools have differing amounts of wire, the more depleted spool can have a higher angular velocity than the adjacent spool despite paying out wire at the same WFS, due to the smaller radius and circumference of wire on the more depleted spool. It can be desirable that the spools mechanically engage each other to allow them to rotate together when possible, but also allow them to rotate at different speeds as needed. Described herein is a tensioning/braking system that allows the two separate welding wire spools mounted together on the wire feeder to rotate together but also independently at different angular velocities should there be a mismatch in how the wires unwind from the spools.

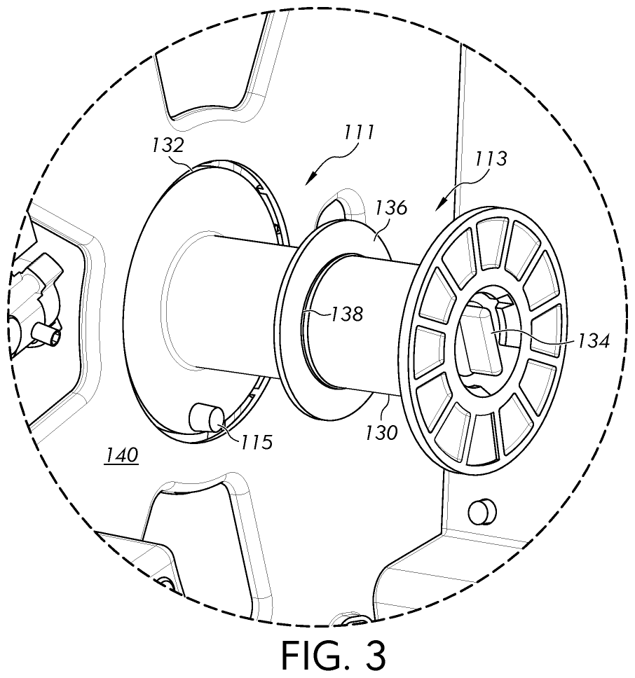

FIG. 3 is a perspective view of the two spindles 111, 113. Each spindle has a hub 130 upon which a welding wire spool is mounted, and an annular flange 132 surrounding the hub. The two spindles 111, 113 are coaxially mounted on a shaft extending laterally within the wire feeder housing and can rotate on the shaft as welding wire is drawn off of the wire spools by the drive rolls. The shaft within the wire feeder housing does not rotate. A fastening device, such as a thumb screw 134, retains the spindles 111, 113 and wire spools on the shaft. The thumb screw 134 can also apply an axial compressive load on the spindles to control how freely they can rotate on the shaft and rotate relative to each other. In addition to allowing for independent movement or rotation of the wire spools, the dual spindle design discussed herein provides for control of the length of the spindle to allow for small-sized spools to fit within the wire feeder case when its access door is closed.

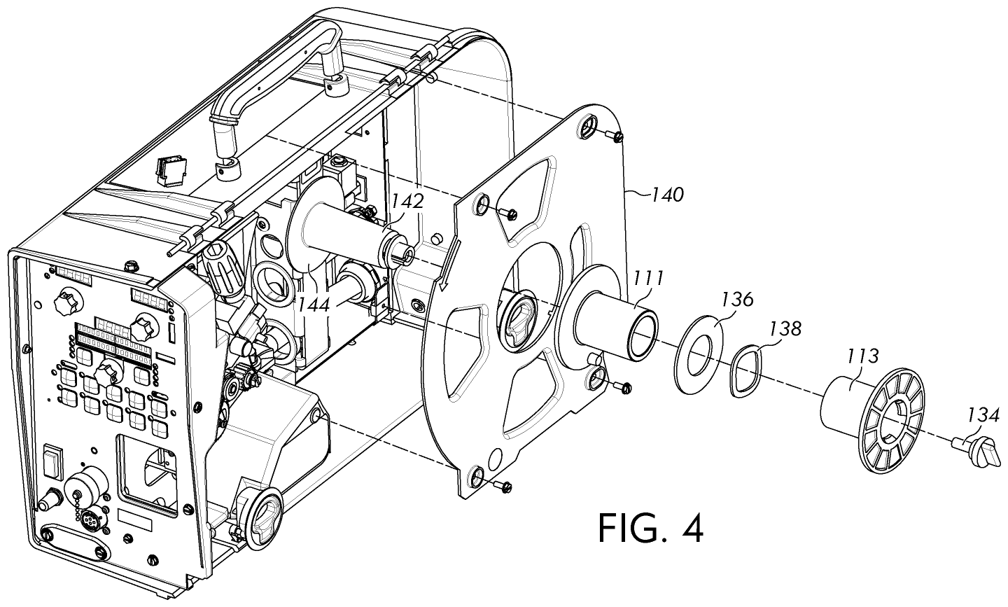

Between the spindles 111, 113 are a disk 136 and a wave washer 138. The wave washer 138 is a biasing member that is located between the inner spindle 111 and the outer spindle 113 and that applies an axial load between the spindles. As the thumb screw 134 is tightened, an axial force is transferred from the outer spindle 113 to the inner spindle 111 by compression of the wave washer 138 between the end face of the outer spindle and the surface of the disk 136. The spindles 111, 113, disk 136, wave washer 138 and thumb screw 134 are shown in the exploded view of FIG. 4.

A cover plate 140 is shown in FIG. 3 and is shown removed in FIG. 4. Removing the cover plate exposes various internal components of the wire feeder. The cover plate has a central opening through which the shaft 142 for the spindles 111, 113 projects. The spindles 111, 113 rotate on the shaft 142, but the shaft itself does not rotate during operation of the wire feeder (during wire pay out). The end of the shaft 142 includes an internal thread for receiving the externally-threaded end of the thumbscrew 134. The outer surface of the end of the shaft 142 includes a slot or keyway for a keyed washer that is mounted within the hub of the outer spindle 113 as part of its tensioning/braking components.

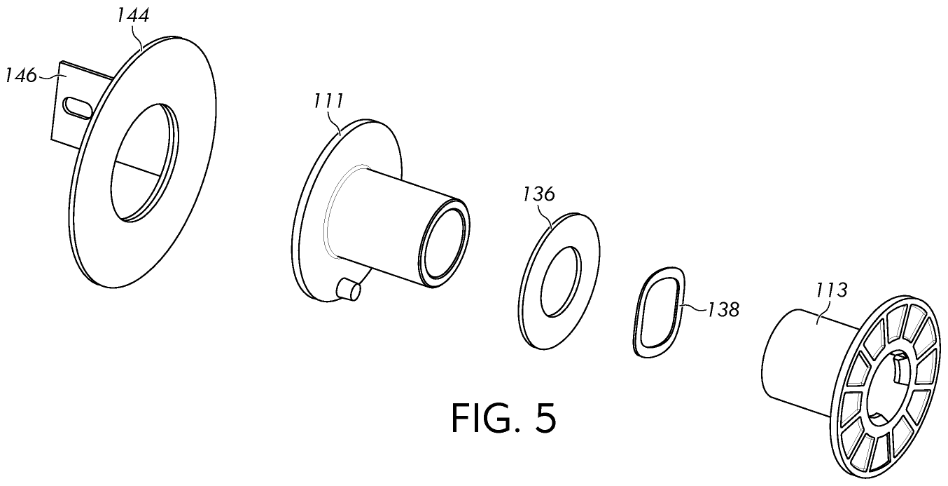

Aligned with the flange of the inner spindle 111 is a friction brake disk 144. The flange of the inner spindle 111 is pressed against the surface of the friction brake disk 144 by the compression of the wave washer 138 against disk 136 between the spindles 111, 113. The friction brake disk 144 does not rotate, and the flat, doughnut-shaped surfaces of the flange of the inner spindle 111 and the friction brake disk 144 rub against each other during wire pay out. This interaction between the friction brake disk 144 and the flange of the inner spindle 111 provide a braking action for the inner spindle and its wire spool when wire pay out stops (e.g., to prevent free-wheeling of the wire spool and unrolling of welding wire within the wire feeder housing). The friction brake disk 144 could be mounted directly to the shaft 142 or be formed integrally with the shaft. However, in an example embodiment, the friction brake disk 144 includes a mounting tab 146 or bracket (FIG. 5) for attaching the friction brake disk to a structural component of the wire feeder. For example, the friction brake disk 144 can be bolted to a post or mast element within the wire feeder housing via the mounting tab 146. Other methods of mounting the friction brake disk 144 within the wire feeder will be apparent to one of ordinary skill in the art. For example, the friction brake disk 144 and the shaft 142 could have complementary keying surfaces (e.g., a flat on the shaft and on the hole in the friction brake disk) to prevent the friction brake disk from rotating. Moreover, the friction brake disk 144 and the shaft 142 could be installed together or simultaneously in the wire feeder, such as by first placing the friction brake disk on the shaft and then threading the shaft onto a mounting stud or into a threaded bore within the wire feeder.

The friction brake disk 144 can be formed from a variety of materials having a desired coefficient of friction (e.g., a suitable amount of friction between the flat, doughnut-shaped surfaces of the friction brake disk and the inner spindle 111 flange). For example, the friction brake disk 144 could be formed from a plastic material, or an elastomeric material, or from cork or a cork-like material. The friction brake disk 144 could also be formed from a non-woven material, such as a sparse non-woven polymer or a felt. The friction brake disk 144 could also have a surface treatment or coating applied to it to achieve the desired coefficient of friction. For example, the friction brake disk 144 could have abrasive surfaces similar to sand paper, or be formed from a metal or polymer and have a knurled finish. One of ordinary skill in the art will appreciate various possible materials of construction and/or surface finishes/treatments for the friction brake disk 144 to provide the braking functionality discussed herein.

FIG. 5 illustrates a stack-up of components mounted along the shaft 142 (FIG. 4) within the wire feeder housing. Starting inward and moving outward, the illustrated components include the friction brake disk 144, the inner spindle 111, the disk 136 and wave washer 138, and the outer spindle 113.

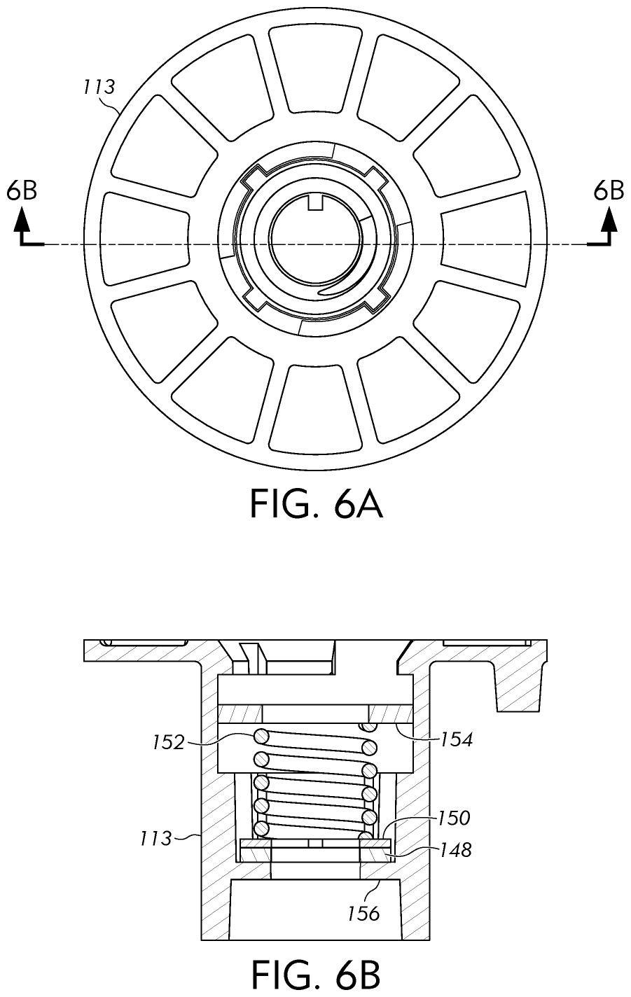

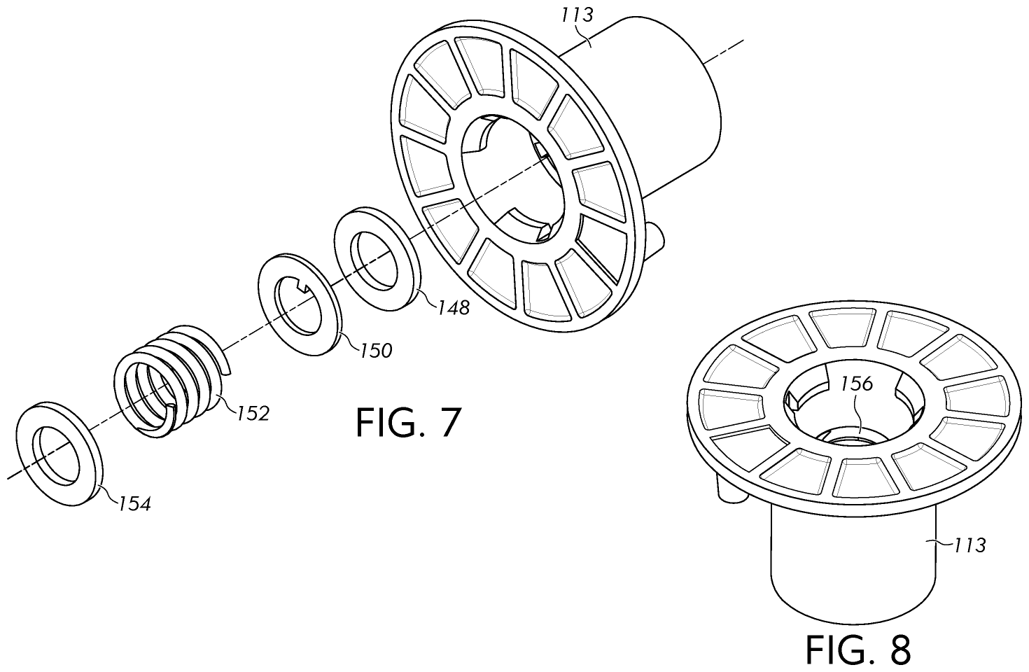

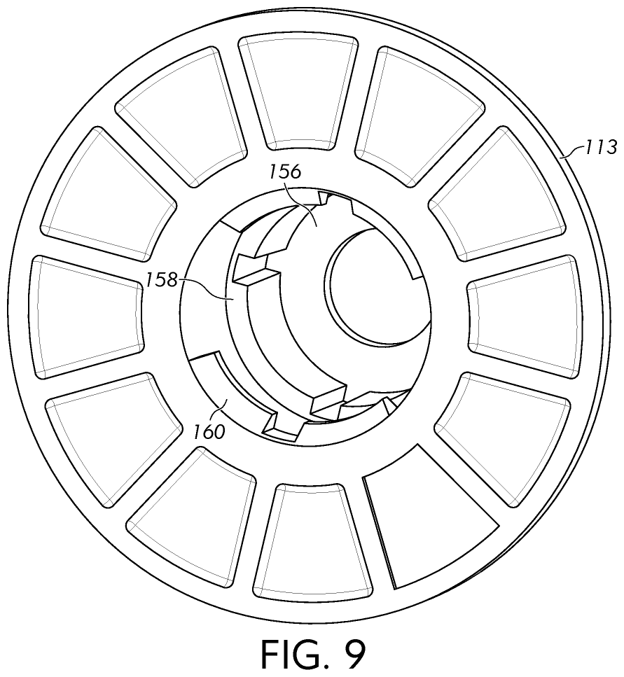

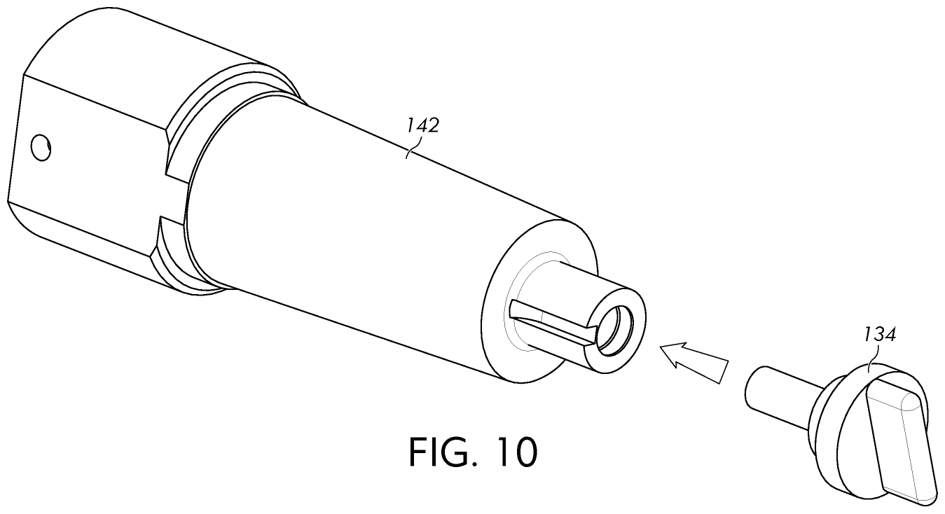

Turning to FIGS. 6-9, the outer spindle 113 can include a capture system within its hub for all of its tension/braking components. This allows removal of the spindle 113 without the worry of losing the multiple components of the tensioning/braking system. The disk 136 and wave washer 138 stack-up (FIG. 5) allow semi-independent braking of the inner and outer spindles, depending on the amount of tension placed on it from the tensioner located in the outer spindle 113. The tension/braking components for the outer spindle 113 can include a friction brake washer 148, a keyed washer 150, an axial tensioning or biasing spring 152 (e.g, a coil spring), and an outer washer 154. The friction brake washer 148 contacts the outer spindle 113. In the example embodiment shown, the friction brake washer 148 is located within the hub of the outer spindle 113 and presses against an internal flange surface 156 of the hub to provide its braking action. The internal flange surface 156 of the outer spindle 113 is best shown in FIG. 9. In an example embodiment, the friction brake washer 148 is a cork washer. However, the friction brake washer 148 could be made from a variety of materials or have a surface treatment, as discussed above with respect to the friction brake disk. As noted above, the outer surface of the end of the shaft 142 (FIG. 4) includes a slot or keyway for the keyed washer 150. The keyed washer 150 provides a surface for the axial tensioning or biasing spring 152 to apply an axial load or bias force to the friction brake washer 148 (e.g., to press the friction brake washer against the internal flange surface 156 of the hub and to make the outer spindle 113 compress the wave washer 138—see FIG. 5). The spring 152 applies a bias force to the friction brake washer 148 through the keyed washer 150, and to the inner spindle 111 through the outer spindle 113, wave washer 138, and disk 136 (FIG. 5). The outer washer 154 provides a surface for the thumb screw 134 (FIG. 4) to compress the axial tensioning or biasing spring 152 as the thumb screw 134 is threaded into the shaft 142 (FIG. 4). As the thumb screw 134 is progressively threaded into the shaft 142 and tightened, the axial load or tension on the spindle system increases when the axial tensioning or biasing spring 152 compresses. Compression of the axial tensioning or biasing spring 152 presses the friction brake washer 148 against the internal flange surface 156 of the outer spindle 113, and the outer spindle compresses the wave washer 138 which forces the inner spindle 111 flange against the friction brake disk 144. FIG. 10 shows the thumb screw 134 and the corresponding internally-threaded end of the shaft 142 that receives the thumb screw.

As noted above, the outer spindle 113 can include a capture system within its hub for all of its tension/braking components to allow removal of the spindle without the worry of losing the multiple components. It can be seen in FIG. 9 that the hub of the outer spindle 113 includes inward projections 158, 160. The friction brake washer 148, keyed washer 150, and axial tensioning or biasing spring 152 can have a smaller diameter that the inward projections 158, 160 to allow them to be dropped into the hub. The outer washer 154 can have a larger diameter than the inward projections 158, 160 so that it can be held captive between the projections and retain the friction brake washer 148, keyed washer 150, and axial tensioning or biasing spring 152 within the hub. The outer washer 154 can be inserted into and removed from the hub by tilting it and inserting it through the gaps between the inward projections.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A welding or additive manufacturing wire drive system, comprising:
a shaft;
an inner spindle mounted on the shaft and comprising a first hub for receiving a first welding wire spool mounted on the inner spindle, and a first flange around the first hub;
an outer spindle mounted coaxially on the shaft with the inner spindle and comprising a second hub for receiving a second welding wire spool mounted on the outer spindle, and a second flange around the second hub;
a first friction brake in contact with the inner spindle;
a second friction brake in contact with the outer spindle; and
a biasing member, located between the inner spindle and the outer spindle, that applies a bias force from the outer spindle to the inner spindle to push the inner spindle against the first friction brake;
wherein the inner spindle and the outer spindle are configured for independent rotation at different angular velocities from each other.

2. The welding or additive manufacturing wire drive system of claim 1, wherein the biasing member comprises a wave washer.

3. The welding or additive manufacturing wire drive system of claim 1, wherein the first friction brake contacts the first flange around the first hub.

4. The welding or additive manufacturing wire drive system of claim 3, further comprising a second friction brake located inside of the outer spindle.

5. The welding or additive manufacturing wire drive system of claim 4, further comprising a second biasing member, wherein the second biasing member applies a further bias force to the second friction brake.

6. A welding or additive manufacturing wire drive system, comprising:
a shaft;
an inner spindle mounted on the shaft and comprising a first hub for receiving a first welding wire spool mounted on the inner spindle, and a first flange around the first hub;
an outer spindle mounted coaxially on the shaft with the inner spindle and comprising a second hub for receiving a second welding wire spool mounted on the outer spindle, and a second flange around the second hub;
a first biasing member located between the inner spindle and the outer spindle;
a first friction brake in contact with the inner spindle;
a second biasing member located inside of the outer spindle; and
a second friction brake in contact with the outer spindle and located inside of the outer spindle,
wherein the inner spindle and the outer spindle are configured for independent rotation on said shaft at different angular velocities from each other, and
wherein the second biasing member applies a bias force to the inner spindle through both of the outer spindle and the first biasing member.

7. The welding or additive manufacturing wire drive system of claim 6, wherein the first biasing member comprises a wave washer.

8. The welding or additive manufacturing wire drive system of claim 7, wherein the second biasing member comprises a coil spring.

9. The welding or additive manufacturing wire drive system of claim 6, wherein the second biasing member applies the bias force to the second friction brake.

10. The welding or additive manufacturing wire drive system of claim 9, further comprising a keyed washer located between the second biasing member and the second friction brake.

11. The welding or additive manufacturing wire drive system of claim 9, wherein the outer spindle includes an internal flange surface located within the second hub, and the second friction brake contacts the internal flange surface.

12. The welding or additive manufacturing wire drive system of claim 6, wherein the first friction brake contacts the first flange around the first hub.

13. A welding or additive manufacturing wire drive system, comprising:
a wire feeder housing;
a shaft extending within the wire feeder housing;
an inner spindle mounted on the shaft and comprising a first hub for receiving a first welding wire spool mounted on the inner spindle, and a first flange around the first hub;
an outer spindle mounted coaxially on the shaft with the inner spindle and comprising a second hub for receiving a second welding wire spool mounted on the outer spindle, and a second flange around the second hub;
a first biasing member located between the inner spindle and the outer spindle;
a first friction brake in contact with the inner spindle;
a second biasing member located inside of the outer spindle; and
a second friction brake in contact with the outer spindle;
wherein the inner spindle and the outer spindle are configured for independent rotation within the wire feeder housing on said shaft at different angular velocities from each other, and
wherein the second biasing member applies a bias force to the inner spindle through both of the outer spindle and the first biasing member.

14. The welding or additive manufacturing wire drive system of claim 13, wherein the first biasing member comprises a wave washer.

15. The welding or additive manufacturing wire drive system of claim 14, wherein the second biasing member comprises a coil spring.

16. The welding or additive manufacturing wire drive system of claim 13, wherein the second biasing member applies the bias force to the second friction brake.

17. The welding or additive manufacturing wire drive system of claim 16, further comprising a keyed washer located between the second biasing member and the second friction brake.

18. The welding or additive manufacturing wire drive system of claim 16, wherein the outer spindle includes an internal flange surface located within the second hub, and the second friction brake contacts the internal flange surface.

19. The welding or additive manufacturing wire drive system of claim 13, wherein the first friction brake contacts the first flange around the first hub.
